(19) United States
(12) Patent Application Publication
(10) Pub. No.: US 2025/0203429 A1
(43) Pub. Date: Jun. 19, 2025

(54) METHODS, DEVICES, AND COMPUTER READABLE MEDIUM FOR COMMUNICATION

(71) Applicant: NEC CORPORATION, Tokyo (JP)

(72) Inventors: Ying ZHAO, Beijing (CN); Yukai GAO, Beijing (CN); Zhaobang MIAO, Beijing (CN); Peng GUAN, Beijing (CN); Gang WANG, Beijing (CN)

(73) Assignee: NEC CORPORATION, Tokyo (JP)

(21) Appl. No.: 18/847,092

(22) PCT Filed: Mar. 15, 2022
(86) PCT No.: PCT/CN2022/081017

§ 371 Date: Sep. 13, 2024

(51) Int. Cl. H04W 24/10; H04L 1/08; H04W 72/25

(52) U.S. Cl. CPC H04W 24/10; H04L 1/08; H04W 72/25

(57) ABSTRACT

Embodiments of the present disclosure relate to methods, devices, and computer readable medium for communication. According to embodiments of the present disclosure, a first terminal device transmits a set of reference signals to a second terminal device on a set of reference signal resources based on a reference signal configuration. The reference signal configuration at least indicates an association between a first transmission of a first reference signal and a second transmission of a last reference signal in the set of reference signals. The second terminal device transmits a measurement report for a reference signal in the set of reference signals on a sidelink resource. The sidelink resource is associated with a reference signal resource on which the reference signal is transmitted. In this way, the selected reference signal resource/beam is indicated based on the index of sidelink resource for the measurement report, thereby different UEs reporting selected reference signal resources/beams without beam collision.

### TECHNICAL FIELD

Embodiments of the present disclosure generally relate to the field of telecommunication, and in particular, to methods, devices, and computer readable medium for communication.

### BACKGROUND

Several technologies have been proposed to improve communication performances. For example, a technology called “beamforming” has been proposed. Beamforming is a particular processing for signals that allow for directional transmission or reception. In order to ensure communication quality, it is very import to select a proper beam for communications. Beam management procedure may be performed to select the proper beam. The beam management procedure may include a set of layer 1/layer 2 (L1/L2) procedures to acquire and maintain a set of transmission reception points (TRPs) and/or user equipment (UE) beams that can be used for downlink (DL) and uplink (UL) transmission/reception. For example, the set of L1/L2 procedures may comprise one or more of: beam measurement, beam determination, beam reporting, beam failure recovery, or beam sweeping. Moreover, since sidelink communication has been proposed, it is worth studying the beam management in the scenario of sidelink communications.

### SUMMARY

In general, example embodiments of the present disclosure provide a solution for communication.

In a first aspect, there is provided a method for communication. The method comprises transmitting, at a first terminal device, a set of reference signals to a second terminal device on a set of reference signal resources based on a reference signal configuration, wherein the reference signal configuration at least indicates an association in time domain between each reference signal resource for each reference signal in the set of reference signals and a sidelink resource for each measurement report with respect to each reference signal; and receiving, from the second terminal device, at least one measurement report for at least one reference signal in the set of reference signals on sidelink resources corresponding to the set of reference signals based on the reference signal configuration.

In a second aspect, there is provided a method for communication. The method comprises receiving, at a second terminal device, a set of reference signals from a first terminal device on a set of reference signal resources based on a reference signal configuration, wherein the reference signal configuration at least indicates an association in time domain between each reference signal resource for each reference signal in the set of reference signals and a sidelink resource for each measurement report with respect to each reference signal; and transmitting, to the first terminal device, at least one measurement report for at least one reference signal in the set of reference signals on sidelink resources corresponding to the set of reference signals based on the reference signal configuration.

In a third aspect, there is provided a terminal device. The terminal device comprises a processing unit; and a memory coupled to the processing unit and storing instructions thereon, the instructions, when executed by the processing unit, causing the terminal device to perform acts comprising: transmitting a set of reference signals to a second terminal device on a set of reference signal resources based on a reference signal configuration, wherein the reference signal configuration at least indicates an association in time domain between each reference signal resource for each reference signal in the set of reference signals and a sidelink resource for each measurement report with respect to each reference signal; and receiving, from the second terminal device, at least one measurement report for at least one reference signal in the set of reference signals on sidelink resources corresponding to the set of reference signals based on the reference signal configuration.

In a fourth aspect, there is provided a terminal device. The terminal device comprises a processing unit; and a memory coupled to the processing unit and storing instructions thereon, the instructions, when executed by the processing unit, causing the terminal device to perform acts comprising: receiving a set of reference signals from a first terminal device on a set of reference signal resources based on a reference signal configuration, wherein the reference signal configuration at least indicates an association in time domain between each reference signal resource for each reference signal in the set of reference signals and a sidelink resource for each measurement report with respect to each reference signal; and transmitting, to the first terminal device, at least one measurement report for at least one reference signal in the set of reference signals on sidelink resources corresponding to the set of reference signals based on the reference signal configuration.

In a fifth aspect, there is provided a computer readable medium having instructions stored thereon, the instructions, when executed on at least one processor, causing the at least one processor to carry out the method according to the first or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIGS. 1A and 1B are schematic diagrams of communication environments in which embodiments of the present disclosure can be implemented;

FIG. 2 illustrates a signaling flow for communications according to some embodiments of the present disclosure;

FIG. 3 illustrates a schematic diagram of sidelink resources according to some embodiments of the present disclosure;

FIGS. 4A-4C illustrate schematic diagrams of inter-slot reference resources for beam management according to some embodiments of the present disclosure, respectively;

FIGS. 5A-5B illustrate schematic diagrams of intra-slot reference resources for beam management according to some embodiments of the present disclosure, respectively;

FIG. 6 is a flowchart of an example method in accordance with an embodiment of the present disclosure;

FIG. 7 is a flowchart of an example method in accordance with an embodiment of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device. In the following description, the terms “terminal device”, “communication device”, “terminal”, “user equipment” and “UE” may be used interchangeably.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz-7125 MHz), FR2 (24.25 GHz to 71 GHz), frequency band larger than 100 GHz as well as Terahertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, it is worth studying the beam management in the scenario of sidelink communications. According to some conventional technologies, a sidelink synchronization/physical broadcast channel block (S-SSB) may be used for the beam management. However, SSB may not be suitable for beam management since a UE may not transmit S-SSB, and multiple UEs may use same resources to transmit S-SSB without UE-specific identity. For beam management, UE1 may transmit a set of beam management (BM) channel state information (CSI) reference signals (RSs) to UE2, and UE2 may report BM results to UE1. At least in case of beam correspondence, a transmitting (TX) beam for UE2 to report BM results seems to be with a transmission beam based on the reception beam for the set of CSI-RS, and UE1 receives BM results based on corresponding transmission beams of CSI-RS. It is not clear how to determine the reception beam for UE1 to receive the BM results from UE2. The Rx beam selection for Tx UE to receive beam report from Rx UE is not involved.

According to some other conventional technologies, the downlink measurement configuration includes an association of reference signal resource and measurement report. However, it is more like a general expressing regarding the connection between reference signal and measurement report without detailed method. Generally speaking, the CSI-RS measurement and reporting configuration also can be treated as a description of association between the CSI-RS resources and corresponding report, i.e. the physical resources and characteristics of CSI-RS/report are given.

In order to solve at least part of the above problems or other potential problems, solutions on sidelink beam management are proposed. According to embodiments of the present disclosure, a first terminal device transmits a set of reference signals to a second terminal device on a set of reference signal resources based on a reference signal configuration. The reference signal configuration at least indicates an association between a first transmission of a first reference signal and a second transmission of a last reference signal in the set of reference signals. The second terminal device transmits a measurement report for a reference signal in the set of reference signals on a sidelink resource. The sidelink resource is associated with a reference signal resource on which the reference signal is transmitted. In this way, the selected reference signal resource/beam is indicated based on the index of sidelink resource for the measurement report, thereby different UEs reporting selected reference signal resources/beams without beam collision.

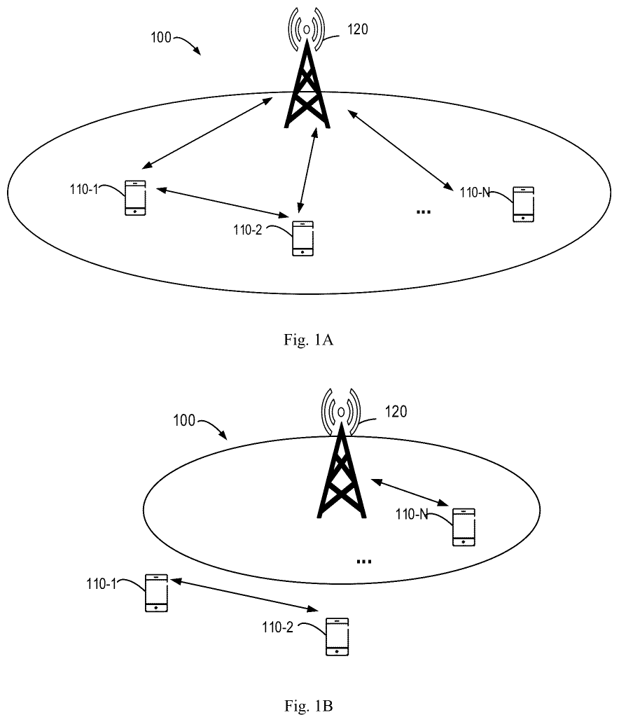

FIGS. 1A and 1B illustrate schematic diagrams of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number.

The communication system 100 further comprises a network device. In the communication system 100, the network device 120 and the terminal devices 110 can communicate data and control information to each other. The terminal devices 110 can also communicate with each other. The numbers of terminal devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols.

In some embodiments, resources for sidelink communications can be scheduled by a network device, which is referred to as mode 1. For example, as shown in FIG. 1a, the terminal devices 110 are in the coverage of the network device 120. In this case, the network device 120 can schedule the resources for the sidelink communications.

On the other hand, resources for sidelink communication can also be determined by UE itself, which is referred to as mode 2. Specifically, as a sidelink communication enhancement, the inter-UE coordination is proposed for mode 2 resource allocation to improve reliability where one of the UEs determines a set of resources and transmits such set of resources to another UE which takes them into consideration when performing resource selection for its own transmission. For example, as shown in FIG. 1a, the terminal devices 110-1 and 110-2 are out of the coverage of the network device 120. In this case, the terminal device 110-1 can schedule the resources for the sidelink communications.

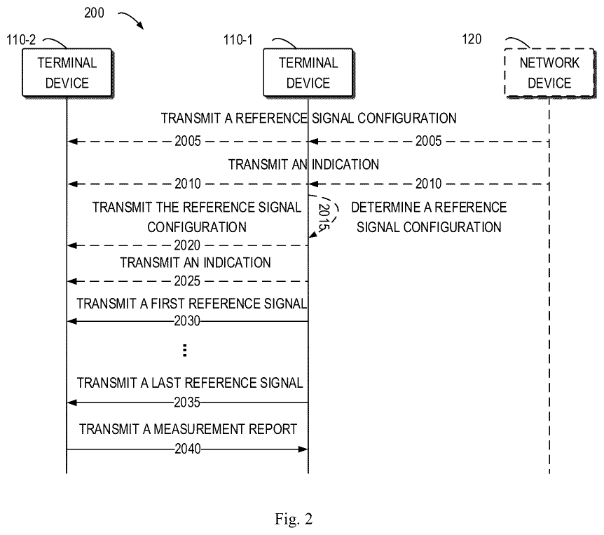

Embodiments of the present disclosure will be described in detail below. Reference is first made to FIG. 2, which shows a signaling chart illustrating process 200 between the terminal device and the network device according to some example embodiments of the present disclosure. Only for the purpose of discussion, the process 200 will be described with reference to FIG. 1. In some embodiments, the process 200 may involve the terminal device 110-1, the terminal device 110-2 and the network device 120 in FIG. 1A. Alternatively, the process 200 may involve the terminal device 110-1 and the terminal device 110-2 in FIG. 1B. The beam correspondence based on the channel reciprocity is assumed for both Tx UE (i.e., the terminal device 110-1) and Rx UE (i.e., the terminal device 110-2), namely, UE is able to determine a UE Tx beam for the UL transmission based on UE's DL measurement on UE's one or more Rx beams. UE is able to determine a UE Rx beam for the DL reception based on the other UE's indication based on UL measurement on UE's one or more Tx beams.

In some embodiments, if the terminal device can support M beams, the number of reference signals for beam management in sidelink can be M. In this case, each beam can be indicated by the corresponding transmission configuration indicator (TCI) state which is associated with a reference signal resource. The TCI state may comprise configuration such as, quasi-colocation (QCL) relationship between downlink references in one reference signal set and the demodulation reference signal ports. The reference signal pattern for beam management can be predefined or (pre) configured to the terminal devices. For example, as shown in FIG. 2, the terminal devices 110-1 and 110-2 can be configured with reference signal resources based on a reference signal configuration. In some embodiments, the reference signal resources may be time division multiplexed. Alternatively, the reference signal resources may be frequency division multiplexed. In other embodiments, the reference signal resources may be code division multiplexed. The indexes of the reference signal resources may be based on slot indexes. Alternatively, the indexes of the reference signal resources may be based on symbol indexes.

In some embodiments, the network device 120 may transmit 2005 the reference signal configuration to the terminal devices 110-1 and 110-2. Alternatively, the terminal device 110-1 may determine 2015 the reference signal configuration. The terminal device 110-1 may transmit 2020 the reference signal configuration to the terminal device 110-2. For example, the reference signal configuration may be transmitted in radio resource control (RRC) signaling. In some embodiments, the reference signal configuration may be transmitted in sidelink control information.

As mentioned above, the reference signal configuration may be transmitted by the network device 120. In this case, the network device 120 may also transmit 2010 an indication to the terminal devices 110-1 and 110-2. If the reference signal configuration is transmitted by the terminal device 110-1, the terminal device 110-1 may transmit said indication to the terminal device 110-2. This indication can be used for triggering transmissions of a set of reference signal. In addition, the indication can be used for triggering a measurement report.

In some embodiments, the reference signal configuration may comprise a report configuration for the measurement report. Alternatively or in addition, the reference signal configuration may comprise the resources for the set of reference signals. For example, the reference signal configuration may comprise a set TCI states associated with the set of reference signals. In addition, the reference signal configuration may comprise a beam sweeping type. For example, the beam sweeping may be per slot. In other words, the beam may be changed per slot. In some embodiments, the beam sweeping may be per symbol. The term “beam sweeping” used herein can refer to a technique to transmit beams in all predefined directions in a transmission burst in a regular interval, each beam used for beam sweeping may or may not have the same size coverage as that of the other beams.

The reference signal configuration may comprise beam sweeping timing parameters. For example, the reference signal configuration may indicate a time offset (represented as “K1”) between a reference signal triggering and a reference signal transmission. For example, as shown in FIG. 2, if the indication is transmitted by the network device 120, the time offset may refer to the time gap between the transmission 2010 of the indication and the transmission 2030 of the first reference signal in the set of reference signal. Alternatively, if the indication is transmitted by the terminal device 110-1, the time offset (represented as “K3”) may refer to the time gap between the transmission 2025 of the indication and the transmission 2030 of the first reference signal. The time gap may comprise a number of slots. In some embodiments, the reference signal configuration may indicate a time offset between the reference signal triggering and the measurement report. For example, as shown in FIG. 2, if the indication is transmitted by the network device 120, the time offset may refer to the time gap between the transmission 2010 of the indication and the transmission 2040 of the measurement report. Alternatively, if the indication is transmitted by the terminal device 110-1, the time offset may refer to the time gap between the transmission 2025 of the indication and the transmission 2040 of the measurement report.

The reference signal configuration also indicates an association between the transmission of the first reference signal and a transmission of the last reference signal in the set of reference signals. In other words, the reference signal configuration may comprise the time duration (represented as “K2”) of beam sweeping procedure from the first reference signal transmission to the end of reference signal transmission with regard to the number of slots. For example, as shown in FIG. 2, the reference signal configuration can indicate the time duration between the transmission 2030 of the first reference signal and the transmission 2035 of the last reference signal.

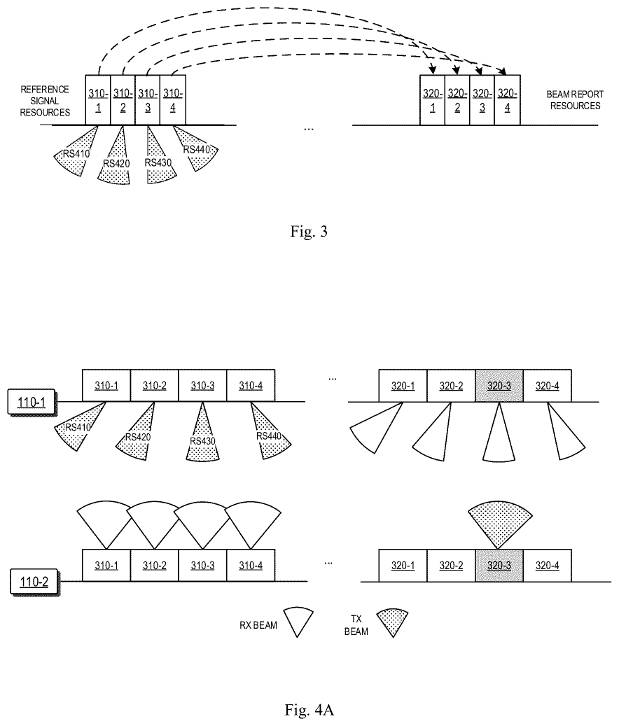

The terminal device 110-1 may perform the beam sweeping based on the reference signal configuration. Referring back to FIG. 2, the terminal device 110-1 may transmit the set of reference signals (e.g. M CSI-RS resources/beam, M>=1) in proper order. For example, the terminal device 110-1 may transmit 2030 the first reference signal on a first reference signal resource. The terminal device 110-1 may transmit 2035 the last reference signal on a last reference signal resource. It should be noted the transmissions of some reference signals are omitted in FIG. 2 for clarity purpose. As shown in FIG. 3, the terminal device 110-1 may transmit the reference signal 410 on the slot 310-1 based on a first TCI state or a first beam. The terminal device 110-1 may then transmit the reference signal 420 on the slot 310-2 based on a second TCI state or a second beam. The terminal device 110-1 may transmit the reference signal 430 on the slot 310-3 based on a third TCI state or a third beam. The terminal device 110-1 may transmit the reference signal 440 on the slot 310-4 based on a fourth TCI state or a fourth beam.

In some embodiments, the terminal devices 110-1 and 110-2 may reserve a set of resources for the reception of the measurement report. Referring to FIG. 3, the terminal device 110-1 may reserve the slots 320-1, 320-2, 320-3 and 320-4 for the reception of the measurement report. The indexes of sidelink resource for the measurement report may correspond to the index of reference signal resources within the resources set. For example, there may be an association between the slots 310-1, 310-2, 310-3, 310-4 and the slots 320-1, 320-2, 320-3, 320-4. Details of such association will be described later. In some embodiments, the terminal device 110-1 may reserve the sidelink resource for the measurement report in a way of slot by slot mode. In other words, the terminal device 110-1 may separately reserve the sidelink resource for the measurement report for each reference signal in each slot. Alternatively, the terminal device 110-1 may reserve the sidelink resource for the measurement report in one-shot mode. In other words, the terminal device 110-1 may reserve all resources for the measurement report for all reference signals at one time. It should be noted that the number of slots shown in FIG. 3 is only an example, not limitation.

In some embodiments, the terminal device 110-2 may receive the set of reference signals using an omnidirectional antenna. Alternatively, the terminal device 110-2 may receive the set of reference signals using a directional antenna. In this case, the terminal device 110-2 may perform a pre-alignment with the terminal device 110-1.

The terminal device 110-2 may perform measurements on the set of reference signals. For example, the terminal device 110-2 may determine reference signal received power (RSRP) of the set of reference signals. In some embodiment, the terminal device 110-2 may determine reference signal received quality (RSRQ) of the set of reference signals. Alternatively, the terminal device 110-2 may determine signal to interference plus noise ratio (SINR) of the set of reference signals. In other embodiments, the terminal device 110-2 may determine received signal strength indication (RSSI) of the set of reference signals. The terminal device 110-2 may determine any other suitable signal strength or quality of the set of reference signals.

In some embodiments, based on the reception of the reference signal configuration and the indication for beam training trigger, the terminal device 110-2 may receive and measure the reference signal on a certain resource corresponding to each beam/TCI state in turn within the same duration for the set of reference signals transmission. This measurement may be repeated before the transmission of the measurement report, the terminal device 110-2 may measure the same set of reference signals with different receiving beam.

In some embodiments, the terminal device 110-2 may determine one or more reference signals from the set of reference signals based on the measurement. For example, the terminal device 110-2 may determine one or more reference signals with RSRP exceeding a threshold RSRP. Alternatively, the one or more reference signals with the beast RSRP among the set of reference signals can be selected by the terminal device 110-2. In some embodiments, the number of the determined one or more reference signals may be preconfigured. Alternatively, the number of the determined one or more reference signals may be up to the terminal device 110-2.

The terminal device 110-1 may monitor potential measurement reports on the sidelink resources. For example, as shown in FIG. 3, the terminal device 110-1 may monitor the slots 320-1, 320-2, 320-3, 320-4 for the measurement reports. In other words, even though the measurement reports may not be transmitted/received on each of the slots 320-1, 320-2, 320-3, 320-4, the terminal device 110-1 may keep monitoring the slots 320-1, 320-2, 320-3, 320-4 and may receive one or more measurements reports on the corresponding one or more slots from the slots 320-1, 320-2, 320-3, 320-4.

The terminal device 110-2 transmits 2040 the measurement report for the reference signal to the terminal device 110-1 on a sidelink resource. The sidelink resource is associated with the reference signal resource on which the reference signal is transmitted. In this way, the selected reference signal resource/beam can be indicated based on the index of sidelink resource for measurement report. For example, as shown in FIG. 3, if the measurement report is about the reference signal 410, the terminal device 110-2 may transmit the measurement report on the slot 320-1. In other words, the terminal device 110-1 can receive the measurement report for the reference signal 410 on the slot 320-1. Since the terminal device 110-1 knows the association between the slot 310-1 and the slot 320-1, the terminal device 110-1 can understand that the reference signal 410 is selected and the first beam associated with the first TCI may be applied by the terminal device 110-1 for the sidelink communications with eh terminal device 110-2. Similarly, if the measurement report is about the reference signal 420, the terminal device 110-2 may transmit the measurement report on the slot 320-2. In other words, the terminal device 110-1 can receive the measurement report for the reference signal 420 on the slot 320-2. Since the terminal device 110-1 knows the association between the slot 310-2 and the slot 320-2, the terminal device 110-1 can understand that the reference signal 420 is selected and the second beam associated with the second TCI may be applied by the terminal device 110-1 for the sidelink communications with the terminal device 110-2.

In some embodiments, if the terminal device 110-2 determines N reference signals, the terminal device 110-2 may transmit N measurement reports for the N reference signals. For example, as shown in FIG. 3, if the reference signals 410 and 420 are selected, the terminal device 110-2 may transmit a first measurement report for the reference signal 410 on the slot 320-1 and transmit a second measurement report for the reference signal 430 on the slot 320-2.

In some embodiments, the measurement report may comprise an indication of the reference signal. Alternatively or in addition, the measurement report may comprise the measurement result of the reference signal. For example, the measurement report may comprise one or more of the followings associated with the reference signal: RSRP, RSSI, RSRQ, or SINR. In other embodiments, the measurement report may comprise the measurement result of the reference signal and an index of the sidelink resource.

In some embodiments, based on the reception of measurement report within K3 time limit, the terminal device 110-1 may feedback acknowledgement/non-acknowledgement (ACK/NACK) information to the terminal device 110-2 with the selected transmit beam to confirm the validation of above beam training procedure. In this way, the terminal devices 110-1 and 110-2 may reach a coarse beam alignment at least.

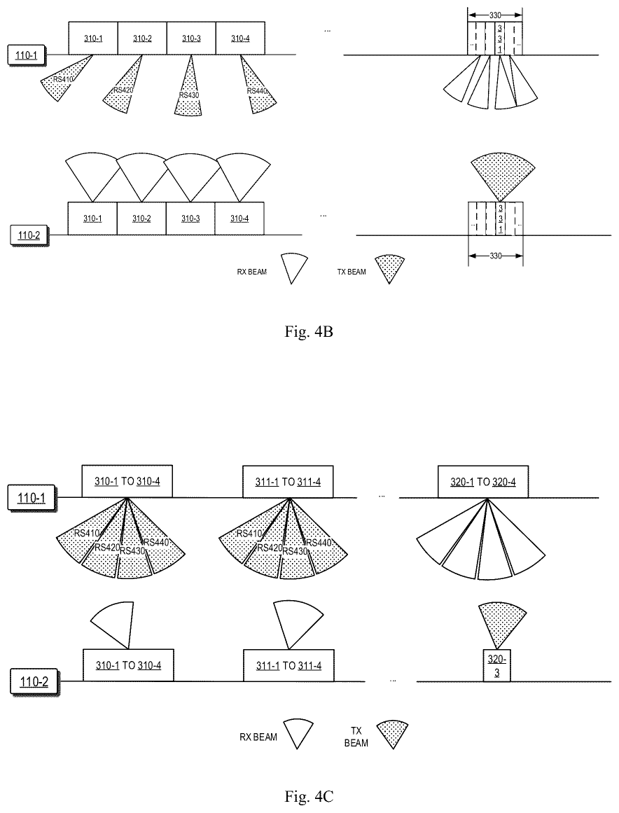

In some embodiments, based on the enhancement on inter-slot reference signals for beam management and reference signal measurement triggering, the association between reference signals through associated beams and corresponding beam report(s) for the terminal devices 110-1 and 110-2 may be defined. In this way, the set of reference signals can be received in a proper way and it has less influence on other terminal devices. Examples are described with reference to FIGS. 4A-4C. It should be noted the number of slots and the number of reference signals shown in FIGS. 4A-4C are only examples.

In some embodiments, the terminal device 110-2 may determine a target slot based on a transmission slot on which the reference signal is received and transmit the measurement report on the target slot. As shown in FIG. 4A, the terminal device 110-1 may transmit the reference signal 410 on the slot 310-1 based on a first TCI state or a first beam. The terminal device 110-1 may then transmit the reference signal 420 on the slot 310-2 based on a second TCI state or a second beam. The terminal device 110-1 may transmit the reference signal 430 on the slot 310-3 based on a third TCI state or a third beam. The terminal device 110-1 may transmit the reference signal 440 on the slot 310-4 based on a fourth TCI state or a fourth beam. The terminal device 110-2 may receive the reference signal 410 on the slot 310-1, the reference signal 420 on the slot 310-2, the reference signal 430 on the slot 310-3, and the reference signal 440 on the slot 310-4. The terminal device 110-2 may determine the reference signal 430 with the best signal quality. Since the terminal device 110-2 knows the association between the slots 310-3 and 320-3, the terminal device 110-2 may transmit the measurement report for the reference signal 430 on the slot 320-3. The terminal device 110-1 can receive the measurement report on the slot 320-3 and may determine that the third beam/third TCI state may be applied for the sidelink communications with the terminal device 110-2.

Alternatively, the terminal device 110-2 may determine at least one target symbol based on a transmission slot on which the reference signal is received and transmit the measurement report on the at least one target symbol. As shown in FIG. 4B, the terminal device 110-1 may transmit the reference signal 410 on the slot 310-1 based on a first TCI state or a first beam. The terminal device 110-1 may then transmit the reference signal 420 on the slot 310-2 based on a second TCI state or a second beam. The terminal device 110-1 may transmit the reference signal 430 on the slot 310-3 based on a third TCI state or a third beam. The terminal device 110-1 may transmit the reference signal 440 on the slot 310-4 based on a fourth TCI state or a fourth beam. The terminal device 110-2 may receive the reference signal 410 on the slot 310-1, the reference signal 420 on the slot 310-2, the reference signal 430 on the slot 310-3, and the reference signal 440 on the slot 310-4. The terminal device 110-2 may determine the reference signal 430 with the best signal quality. Since the terminal device 110-2 knows the association between the slot 310-3 and the symbol(s) 331 on the slot 330, the terminal device 110-2 may transmit the measurement report for the reference signal 430 in the symbol 331. The terminal device 110-1 can receive the measurement report in the symbol(s) 331 and may determine that the third beam/third TCI state may be applied for the sidelink communications with the terminal device 110-2.

In some embodiments, the terminal device 110-1 may transmit the set of reference signals on a first set of slots and perform the repetition of the set reference signals on a second set of slots. As shown in FIG. 4C, the terminal device 110-1 may transmit the reference signal 410 on the slot 310-1 based on a first TCI state or a first beam. The terminal device 110-1 may then transmit the reference signal 420 on the slot 310-2 based on a second TCI state or a second beam. The terminal device 110-1 may transmit the reference signal 430 on the slot 310-3 based on a third TCI state or a third beam. The terminal device 110-1 may transmit the reference signal 440 on the slot 310-4 based on a fourth TCI state or a fourth beam. The terminal device 110-2 may receive, with a first receiving beam, the reference signal 410 on the slot 310-1, the reference signal 420 on the slot 310-2, the reference signal 430 on the slot 310-3, and the reference signal 420 on the slot 310-2, the reference signal 440 on the slot 310-4. After a predetermine duration, the terminal device 110-1 may retransmit the reference signal 410 on the slot 311-1 based on a first TCI state or a first beam. The terminal device 110-1 may retransmit the reference signal 420 on the slot 311-2 based on a second TCI state or a second beam. The terminal device 110-1 may retransmit the reference signal 430 on the slot 311-3 based on a third TCI state or a third beam. The terminal device 110-1 may retransmit the reference signal 440 on the slot 311-4 based on a fourth TCI state or a fourth beam. The terminal device 110-2 may receive, with a second receiving beam, the reference signal 410 on the slot 311-1, the reference signal 420 on the slot 311-2, the reference signal 430 on the slot 311-3, and the reference signal 440 on the slot 311-4. The terminal device 110-2 may determine the reference signal 430 with the best signal quality. Since the terminal device 110-2 knows the association between the slots 311-3 and 320-3, the terminal device 110-2 may transmit the measurement report for the reference signal 430 on the slot 320-3. The terminal device 110-1 can receive the measurement report on the slot 320-3 and may determine that the third beam/third TCI state may be applied for the sidelink communications with the terminal device 110-2.

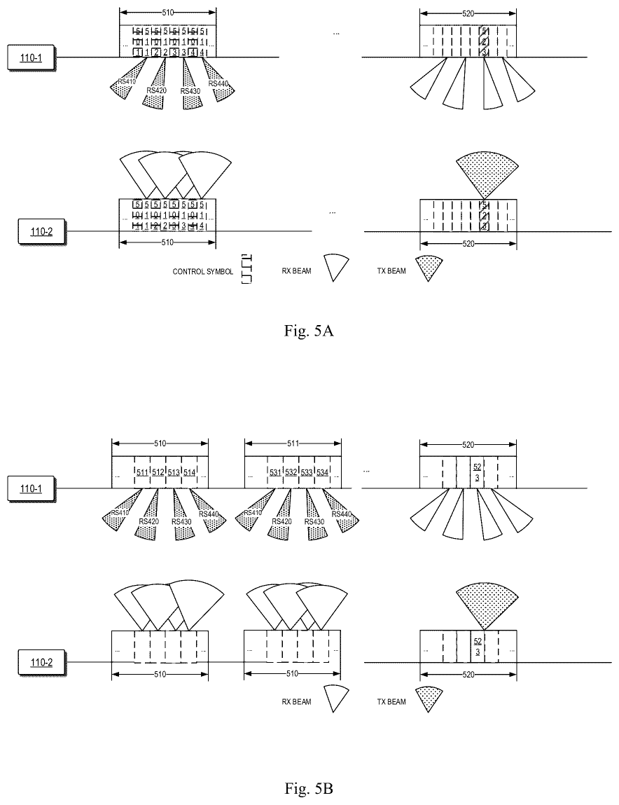

In some embodiments, based on the enhancement on intra-slot reference signals for beam management and reference signal measurement triggering, the association between reference signals through associated beams and corresponding beam report(s) for the terminal devices 110-1 and 110-2 may be defined. In this way, it can save resources for the reference signals. Examples are described with reference to FIGS. 5A-5B. It should be noted the number of slots and the number of reference signals shown in FIGS. 5A-5B are only examples.

In some embodiments, the terminal device 110-1 may transmit the set of reference signals on a set of symbols with a control signal. There may a control symbol between two adjacent symbols or two adjacent subsets of symbols in the set of symbols. The terminal device 110-2 may determine at least one target symbol based on a transmission symbol on which the reference signal is received and transmit the measurement report on the at least one target symbol. As shown in FIG. 5A, the symbols 501 502, 503 and 504 in the slot 510 may be control symbols, for example, automatic gain control (AGC) symbols. The terminal device 110-1 may transmit the reference signal 410 on the symbol 511 based on a first TCI state or a first beam. The terminal device 110-1 may then transmit the reference signal 420 on the symbol 512 based on a second TCI state or a second beam. The terminal device 110-1 may transmit the reference signal 430 on the symbol 513 based on a third TCI state or a third beam. The terminal device 110-1 may transmit the reference signal 440 on the symbol 514 based on a fourth TCI state or a fourth beam. The terminal device 110-2 may receive the reference signal 410 on the symbol 511, the reference signal 420 on the symbol 512, the reference signal 430 on the symbol 513, and the reference signal 440 on the symbol 514. The terminal device 110-2 may determine the reference signal 430 with the best signal quality. Since the terminal device 110-2 knows the association between the symbol 513 and the symbol(s) 523 in the slot 520, the terminal device 110-2 may transmit the measurement report for the reference signal 430 on the symbol 523. The terminal device 110-1 can receive the measurement report on the symbol(s) 523 and may determine that the third beam/third TCI state may be applied for the sidelink communications with the terminal device 110-2.

In some embodiments, the terminal device 110-1 may transmit the set of reference signals on a set of symbols. The terminal device 110-2 may determine at least one target symbol based on a transmission symbol on which the reference signal is received and transmit the measurement report on the at least one target symbol. As shown in FIG. 5B, the terminal device 110-1 may transmit the reference signal 410 on the symbol 511 in the slot 510 based on a first TCI state or a first beam. The terminal device 110-1 may then transmit the reference signal 420 on the symbol 512 based on a second TCI state or a second beam. The terminal device 110-1 may transmit the reference signal 430 on the symbol 513 based on a third TCI state or a third beam. The terminal device 110-1 may transmit the reference signal 440 on the symbol 514 based on a fourth TCI state or a fourth beam. The terminal device 110-2 may receive the reference signal 410 on the symbol 511, the reference signal 420 on the symbol 512, the reference signal 430 on the symbol 513, and the reference signal 440 on the symbol 514. The terminal device 110-2 may determine the reference signal 430 with the best signal quality. Since the terminal device 110-2 knows the association between the symbol 513 and the symbol(s) 523 in the slot 520, the terminal device 110-2 may transmit the measurement report for the reference signal 430 on the symbol 523. The terminal device 110-1 can receive the measurement report on the symbol(s) 523 and may determine that the third beam/third TCI state may be applied for the sidelink communications with the terminal device 110-2.

In some embodiments, the terminal device 110-1 may transmit the set of reference signals on a first set of symbols in a first slot and perform the repetition of the set reference signals on a second set of symbols in a second slot. As shown in FIG. 5B, the terminal device 110-1 may retransmit the reference signal 410 on the symbol 531 in the slot 511 based on a first TCI state or a first beam. The terminal device 110-1 may then retransmit the reference signal 420 on the symbol 532 in the slot 511 based on a second TCI state or a second beam. The terminal device 110-1 may retransmit the reference signal 430 on the symbol 533 in the slot 511 based on a third TCI state or a third beam. The terminal device 110-1 may retransmit the reference signal 440 on the symbol 534 in the slot 511 based on a fourth TCI state or a fourth beam. The terminal device 110-2 may receive the reference signal 410 on the symbol 531, the reference signal 420 on the symbol 532, the reference signal 430 on the symbol 533, and the reference signal 440 on the symbol 534. The terminal device 110-2 may determine the reference signal 430 with the best signal quality. Since the terminal device 110-2 knows the association between the symbol 533 and the symbol(s) 523 in the slot 520, the terminal device 110-2 may transmit the measurement report for the reference signal 430 on the symbol 523. The terminal device 110-1 can receive the measurement report on the symbol(s) 523 and may determine that the third beam/third TCI state may be applied for the sidelink communications with the terminal device 110-2.

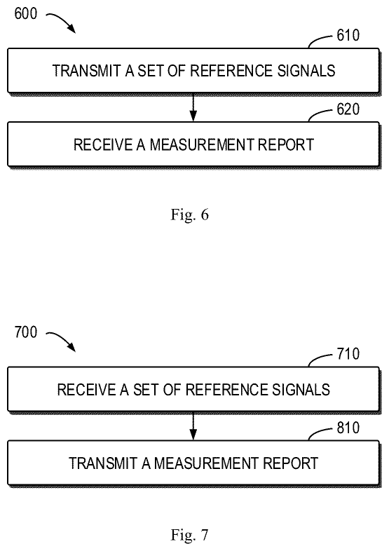

FIG. 6 shows a flowchart of an example method 600 in accordance with an embodiment of the present disclosure. The method 600 can be implemented at any suitable devices. Only for the purpose of illustrations, the method 600 can be implemented at a terminal device 110-1 as shown in FIG. 1.

In some embodiments, if the terminal device can support M beams, the number of reference signals for beam management in sidelink can be M. In this case, each beam can be indicated by the corresponding transmission configuration indicator (TCI) state which is associated with a reference signal resource. The TCI state may comprise configuration such as, quasi-colocation (QCL) relationship between downlink references in one reference signal set and the demodulation reference signal ports. The reference signal pattern for beam management can be predefined or (pre) configured to the terminal devices. For example, the terminal devices 110-1 and 110-2 can be configured with reference signal resources based on a reference signal configuration. In some embodiments, the reference signal resources may be time division multiplexed. Alternatively, the reference signal resources may be frequency division multiplexed. In other embodiments, the reference signal resources may be code division multiplexed. The indexes of the reference signal resources may be based on slot indexes. Alternatively, the indexes of the reference signal resources may be based on symbol indexes.

In some embodiments, the terminal device 110-1 may receive the reference signal configuration from the network device 120. Alternatively, the terminal device 110-1 may determine the reference signal configuration. The terminal device 110-1 may transmit the reference signal configuration to the terminal device 110-2. For example, the reference signal configuration may be transmitted in radio resource control (RRC) signaling.

As mentioned above, the reference signal configuration may be transmitted by the network device 120. In this case, the terminal device 110-1 may also receive an indication from the network device 120. If the reference signal configuration is transmitted by the terminal device 110-1, the terminal device 110-1 may transmit said indication to the terminal device 110-2. This indication can be used for triggering transmissions of a set of reference signal. In addition, the indication can be used for triggering a measurement report.

In some embodiments, the reference signal configuration may comprise a report configuration for the measurement report. Alternatively or in addition, the reference signal configuration may comprise the resources for the set of reference signals. For example, the reference signal configuration may comprise a set TCI states associated with the set of reference signals. In addition, the reference signal configuration may comprise a beam sweeping type. For example, the beam sweeping may be per slot. In other words, the beam may be changed per slot. In some embodiments, the beam sweeping may be per symbol. The term “beam sweeping” used herein can refer to a technique to transmit beams in all predefined directions in a burst in a regular interval.

The reference signal configuration may comprise beam sweeping timing parameters. For example, the reference signal configuration may indicate a time offset (represented as “K1”) between a reference signal triggering and a reference signal transmission. Alternatively, if the indication is transmitted by the terminal device 110-1, the time offset (represented as “K3”) may refer to the time gap between the transmission 2025 of the indication and the transmission 2030 of the first reference signal. The time gap may comprise a number of slots. In some embodiments, the reference signal configuration may indicate a time offset between the reference signal triggering and the measurement report.

The reference signal configuration also indicates an association between the transmission of the first reference signal and a transmission of the last reference signal in the set of reference signals. In other words, the reference signal configuration may comprise the time duration (represented as “K2”) of beam sweeping procedure from the first reference signal transmission to the end of reference signal transmission with regard to the number of slots.

At block 610, the terminal device 110-1 transmits the set of reference signals to the terminal device 110-2 on a set of reference signal resources based on the reference signal configuration. The terminal device 110-1 may transmit the set of reference signals (e.g. M CSI-RS resources/beam, M>=1) in proper order. The terminal device 110-1 may perform the beam sweeping based on the reference signal configuration.

In some embodiments, the terminal device 110-1 may reserve a set of resources for the reception of the measurement report. In some embodiments, the terminal device 110-1 may reserve the sidelink resource for the measurement report in a way of slot by slot mode. In other words, the terminal device 110-1 may separately reserve the sidelink resource for the measurement report for each reference signal in each slot. Alternatively, the terminal device 110-1 may reserve the sidelink resource for the measurement report in one-shot mode. In other words, the terminal device 110-1 may reserve all resources for the measurement report for all reference signals at one time. It should be noted that the number of slots shown in FIG. 3 is only an example, not limitation.

At block 620, the terminal device 110-1 receives the measurement report for the reference signal from the terminal device 110-2 on a sidelink resource. The sidelink resource is associated with the reference signal resource on which the reference signal is transmitted. In this way, the selected reference signal resource/beam can be indicated based on the index of sidelink resource for measurement report.

In some embodiments, if the terminal device 110-2 determines N reference signals, the terminal device 110-1 may receive N measurement reports for the N reference signals.

In some embodiments, the measurement report may comprise an indication of the reference signal. Alternatively or in addition, the measurement report may comprise the measurement result of the reference signal. For example, the measurement report may comprise one or more of the followings associated with the reference signal: RSRP, RSSI, RSRQ, or SINR. In other embodiments, the measurement report may comprise the measurement result of the reference signal and the resource indicator of the reference signal.

In some embodiments, based on the reception of measurement report within K3 time limit, the terminal device 110-1 may feedback acknowledgement/non-acknowledgement (ACK/NACK) information to the terminal device 110-2 with the selected transmit beam to confirm the validation of above beam training procedure. In this way, the terminal devices 110-1 and 110-2 may reach a coarse beam alignment at least.

In some embodiments, based on the enhancement on inter-slot reference signals for beam management and reference signal measurement triggering, the association between reference signals through associated beams and corresponding beam report(s) for the terminal devices 110-1 and 110-2 may be defined. In this way, the set of reference signals can be received in a proper way and it has less influence on other terminal devices.

In some embodiments, the terminal device 110-1 may receive the measurement report on the target slot. Alternatively, the terminal device 110-1 may receive the measurement report on the at least one target symbol.

In some embodiments, the terminal device 110-1 may transmit the set of reference signals on a first set of slots and perform the repetition of the set reference signals on a second set of slots.

In some embodiments, based on the enhancement on intra-slot reference signals for beam management and reference signal measurement triggering, the association between reference signals through associated beams and corresponding beam report(s) for the terminal devices 110-1 and 110-2 may be defined. In this way, it can save resources for the reference signals.

In some embodiments, the terminal device 110-1 may transmit the set of reference signals on a set of symbols. There may be a control symbol between two adjacent symbols or two adjacent subsets of symbols in the set of symbols. The terminal device 110-1 may receive the measurement report on the at least one target symbol.

In some embodiments, the terminal device 110-1 may transmit the set of reference signals on a set of symbols. The terminal device 110-1 may receive the measurement report on the at least one target symbol. In some embodiments, the terminal device 110-1 may transmit the set of reference signals on a first set of symbols in a first slot and perform the repetition of the set reference signals on a second set of symbols in a second slot.

FIG. 7 shows a flowchart of an example method 700 in accordance with an embodiment of the present disclosure. The method 700 can be implemented at any suitable devices. Only for the purpose of illustrations, the method 700 can be implemented at a terminal device 110-2 as shown in FIG. 1. The network device 110-2 may have a plurality of antenna ports/panels.

In some embodiments, if the terminal device can support M beams, the number of reference signals for beam management in sidelink can be M. In this case, each beam can be indicated by the corresponding transmission configuration indicator (TCI) state which is associated with a reference signal resource. The TCI state may comprise configuration such as, quasi-colocation (QCL) relationship between downlink references in one reference signal set and the demodulation reference signal ports. The reference signal pattern for beam management can be predefined or (pre)configured to the terminal devices. For example, the terminal device 110-2 can be configured with reference signal resources based on a reference signal configuration. In some embodiments, the reference signal resources may be time division multiplexed. Alternatively, the reference signal resources may be frequency division multiplexed. In other embodiments, the reference signal resources may be code division multiplexed. The indexes of the reference signal resources may be based on slot indexes. Alternatively, the indexes of the reference signal resources may be based on symbol indexes.

In some embodiments, the terminal device 110-2 may receive the reference signal configuration from the network device 120. Alternatively, the terminal device 110-2 may receive the reference signal configuration from the terminal device 110-1. For example, the reference signal configuration may be transmitted in radio resource control (RRC) signaling.

As mentioned above, the reference signal configuration may be transmitted by the network device 120. In this case, the terminal device 110-2 may also receive an indication from the network device 120. If the reference signal configuration is transmitted by the terminal device 110-1, the terminal device 110-2 may receive said indication from the terminal device 110-1. This indication can be used for triggering transmissions of a set of reference signal. In addition, the indication can be used for triggering a measurement report.

In some embodiments, the reference signal configuration may comprise a report configuration for the measurement report. Alternatively or in addition, the reference signal configuration may comprise the resources for the set of reference signals. For example, the reference signal configuration may comprise a set of TCI states associated with the set of reference signals. In addition, the reference signal configuration may comprise a beam sweeping type. For example, the beam sweeping may be per slot. In other words, the beam may be changed per slot. In some embodiments, the beam sweeping may be per symbol.

The reference signal configuration may comprise beam sweeping timing parameters. For example, the reference signal configuration may indicate a time offset (represented as “K1”) between a reference signal triggering and a reference signal transmission. The time gap may comprise a number of slots. In some embodiments, the reference signal configuration may indicate a time offset between the reference signal triggering and the measurement report.

The reference signal configuration also indicates an association between the transmission of the first reference signal and a transmission of the last reference signal in the set of reference signals. In other words, the reference signal configuration may comprise the time duration (represented as “K2”) of beam sweeping procedure from the first reference signal transmission to the end of reference signal transmission with regard to the number of slots.

At block 710, the terminal device 110-2 receives a set of reference signals from the terminal device 110-1 on a set of reference signal resources based on the reference signal configuration. In some embodiments, the terminal device 110-2 may receive the set of reference signals using an omnidirectional antenna. Alternatively, the terminal device 110-2 may receive the set of reference signals using a directional antenna. In this case, the terminal device 110-2 may perform a pre-alignment with the terminal device 110-1.

The terminal device 110-2 may perform measurements on the set of reference signals. For example, the terminal device 110-2 may determine reference signal received power (RSRP) of the set of reference signals. In some embodiment, the terminal device 110-2 may determine reference signal received quality (RSRQ) of the set of reference signals. Alternatively, the terminal device 110-2 may determine signal to interference plus noise ratio (SINR) of the set of reference signals. In other embodiments, the terminal device 110-2 may determine received signal strength indication (RSSI) of the set of reference signals. The terminal device 110-2 may determine any other suitable signal strength or quality of the set of reference signals.

In some embodiments, based on the reception of the reference signal configuration and the indication for beam training trigger, the terminal device 110-2 may receive and measure the reference signal on a certain resource corresponding to each beam/TCI state in turn within the same duration for the set of reference signals transmission. This measurement may be repeated before the transmission of the measurement report, the terminal device 110-2 may measure the same set of reference signals with different receiving beam.

In some embodiments, the terminal device 110-2 may determine one or more reference signals from the set of reference signals based on the measurement. For example, the terminal device 110-2 may determine one or more reference signals with RSRP exceeding a threshold RSRP. Alternatively, the one or more reference signals with the beast RSRP among the set of reference signals can be selected by the terminal device 110-2. In some embodiments, the number of the determined one or more reference signals may be preconfigured. Alternatively, the number of the determined one or more reference signals may be up to the terminal device 110-2.

At block 720, the terminal device 110-2 transmits the measurement report for the reference signal to the terminal device 110-1 on a sidelink resource. The sidelink resource is associated with the reference signal resource on which the reference signal is transmitted. In this way, the selected reference signal resource/beam can be indicated based on the index of sidelink resource for measurement report. In some embodiments, if the terminal device 110-2 determines N reference signals, the terminal device 110-2 may transmit N measurement reports for the N reference signals.

In some embodiments, the measurement report may comprise an indication of the reference signal. Alternatively or in addition, the measurement report may comprise the measurement result of the reference signal. For example, the measurement report may comprise one or more of the followings associated with the reference signal: RSRP, RSSI, RSRQ, or SINR. In other embodiments, the measurement report may comprise the measurement result of the reference signal and the resource indicator of the reference signal.

In some embodiments, based on the reception of measurement report within K3 time limit, the terminal device 110-2 may receive acknowledgement/non-acknowledgement (ACK/NACK) information from the terminal device 110-1 with the selected transmit beam to confirm the validation of above beam training procedure. In this way, the terminal devices 110-1 and 110-2 may reach a coarse beam alignment at least.

In some embodiments, based on the enhancement on inter-slot reference signals for beam management and reference signal measurement triggering, the association between reference signals through associated beams and corresponding beam report(s) for the terminal devices 110-1 and 110-2 may be defined. In this way, the set of reference signals can be received in a proper way and it has less influence on other terminal devices.

In some embodiments, the terminal device 110-2 may determine a target slot based on a transmission slot on which the reference signal is received and transmit the measurement Alternatively, the terminal device 110-2 may determine at least report on the target slot. one target symbol based on a transmission slot on which the reference signal is received and transmit the measurement report on the at least one target symbol.

In some embodiments, based on the enhancement on intra-slot reference signals for beam management and reference signal measurement triggering, the association between reference signals through associated beams and corresponding beam report(s) for the terminal devices 110-1 and 110-2 may be defined. In this way, it can save resources for the reference signals.

In some embodiments, the terminal device 110-1 may transmit the set of reference signals on a set of symbols. There may a control symbol between two adjacent symbols or two adjacent subsets of symbols in the set of symbols. The terminal device 110-2 may determine at least one target symbol based on a transmission symbol on which the reference signal is received and transmit the measurement report on the at least one target symbol.

In some embodiments, the terminal device 110-1 may transmit the set of reference signals on a set of symbols. The terminal device 110-2 may determine at least one target symbol based on a transmission symbol on which the reference signal is received and transmit the measurement report on the at least one target symbol.

In some embodiments, a first terminal device comprises circuitry configured to perform: transmitting a set of reference signals to a second terminal device on a set of reference signal resources based on a reference signal configuration, wherein the reference signal configuration at least indicates an association in time domain between each reference signal resource for each reference signal in the set of reference signals and a sidelink resource for each measurement report with respect to each reference signal; and receiving, from the second terminal device, at least one measurement report for at least one reference signal in the set of reference signals on sidelink resources corresponding to the set of reference signals based on the reference signal configuration.

In some embodiments, the first terminal device comprises circuitry configured to perform transmitting the set of reference signals by: transmitting the set of reference signals on a set of slots. In some embodiments, the first terminal device comprises circuitry configured to perform receiving the at least one measurement report for the at least one reference signal by: receiving the at least one measurement report on target slots corresponding to the set of reference signals.

In some embodiments, the first terminal device comprises circuitry configured to perform transmitting the set of reference signals by: transmitting the set of reference signals on a set of slots. In some embodiments, the first terminal device comprises circuitry configured to perform receiving the at least one measurement report for the at least one reference signal by: receiving the at least one measurement report on target symbols corresponding to the set of reference signals.

In some embodiments, the first terminal device comprises circuitry configured to perform transmitting the set of reference signals by: transmitting the set of reference signals on a first set of slots; and performing a repetition of the set of reference signals on a second set of slots.

In some embodiments, the first terminal device comprises circuitry configured to perform transmitting the set of reference signals by: transmitting the set of reference signals on a set of symbols with a control signal between two adjacent symbols or two adjacent subsets of symbols in the set of symbols. In some embodiments, the first terminal device comprises circuitry configured to perform receiving the at least one measurement report for the at least one reference signal by: receiving the at least one measurement report on target symbols corresponding to the set of reference signals.

In some embodiments, the first terminal device comprises circuitry configured to perform transmitting the set of reference signals by: transmitting the set of reference signals on a set of consecutive symbols. In some embodiments, the first terminal device comprises circuitry configured to perform receiving the at least one measurement report for the at least one reference signal by: receiving the at least one measurement report on target symbols corresponding to the set of reference signals.

In some embodiments, the first terminal device comprises circuitry configured to perform transmitting the set of reference signals by: transmitting the set of reference signals on a first set of symbols in a first slot; and performing a repetition of the set of reference signals on a second set of symbols in a second slot.

In some embodiments, the first terminal device comprises circuitry configured to perform receiving the reference signal configuration from a network device; and receiving an indication for triggering transmissions of the set of reference signals.

In some embodiments, the first terminal device comprises circuitry configured to perform determining the reference signal configuration; transmitting the reference signal configuration to the second terminal device; and reserving a set of sidelink resources for the transmission of the set of reference signals and the reception of the at least one measurement report.

In some embodiments, the reference signal configuration further comprises at least one of: a set of transmission configuration indicator (TCI) states associated with the set of reference signal resources, a beam sweeping type, a beam sweeping repetition indicator, or a set of beam sweeping timing parameters.

In some embodiments, the at least one measurement report further comprises an index of the sidelink resource.

In some embodiments, the first terminal device comprises circuitry configured to perform transmitting the set of reference signals by transmitting the set of reference signals in a predetermined order. In some embodiments, the first terminal device comprises circuitry configured to perform receiving the at least one measurement report for the at least one reference signal by receiving the at least one measurement report on the sidelink resources in the predetermined order.

In some embodiments, the set of reference signals are a set of channel state information reference signals (CSI-RSs).

In some embodiments, the sidelink resources are physical sidelink shared channel (PSSCH) resources.

In some embodiments, the reference signal configuration at least indicates a time duration from a first transmission of a first reference signal to a second transmission of a last reference signal in the set of reference signals.

In some embodiments, a second terminal device comprises circuitry configured to perform receiving a set of reference signals from a first terminal device on a set of reference signal resources based on a reference signal configuration, wherein the reference signal configuration at least indicates an association in time domain between each reference signal resource for each reference signal in the set of reference signals and a sidelink resource for each measurement report with respect to each reference signal; and transmitting, to the first terminal device, at least one measurement report for at least one reference signal in the set of reference signals on sidelink resources corresponding to the set of reference signals based on the reference signal configuration.

In some embodiments, the second terminal device comprises circuitry configured to perform receiving the set of reference signals by receiving the set of reference signals on a set of slots. In some embodiments, the second device comprises circuitry configured to perform transmitting the at least one measurement report for the at least one reference signal by: determining target slots corresponding to the set of reference signals; and transmitting the at least one measurement report on the target slots.

In some embodiments, the second terminal device comprises circuitry configured to perform receiving the set of reference signals by receiving the set of reference signals on a set of slots with a control signal. In some embodiments, the second device comprises circuitry configured to perform transmitting the at least one measurement report for the at least one reference signal by: determining target symbols corresponding to the set of reference signals; and transmitting the at least one measurement report on the target symbols.

In some embodiments, the second terminal device comprises circuitry configured to perform receiving the set of reference signals by receiving the set of reference signals on a first set of slots; and receiving a repetition of the set of reference signals on a second set of slots.

In some embodiments, the second terminal device comprises circuitry configured to perform receiving the set of reference signals by receiving the set of reference signals on a set of symbols with a control signal between two adjacent symbols or two adjacent subsets of symbols in the set of symbols. In some embodiments, the second device comprises circuitry configured to perform transmitting the at least one measurement report for the at least one reference signal by: determining target symbols corresponding to the set of reference signals; and transmitting the at least one measurement report on the target symbols.

In some embodiments, the second terminal device comprises circuitry configured to perform receiving the set of reference signals by receiving the set of reference signals on a set of consecutive symbols. In some embodiments, the second device comprises circuitry configured to perform transmitting the at least one measurement report for the at least one reference signal by: determining target symbols corresponding to the set of reference signals; and transmitting the at least one measurement report on the target symbols.

In some embodiments, the second terminal device comprises circuitry configured to perform receiving the set of reference signals by receiving the set of reference signals on a first set of symbols in a first slot; and receiving a repetition of the set of reference signals on a second set of symbols in a second slot.

In some embodiments, the second terminal device comprises circuitry configured to perform receiving the reference signal configuration from a network device; or receiving the reference signal configuration from the first terminal device.

In some embodiments, the second terminal device comprises circuitry configured to perform receiving an indication for triggering of transmissions of the set of reference signals.

In some embodiments, the reference signal configuration further comprises at least one of: a set of transmission configuration indicator (TCI) states associated with the set of reference signal resources, a beam sweeping type, a beam sweeping repetition indicator, or a set of beam sweeping timing parameters.

In some embodiments, the measurement report further comprises an index of the sidelink resource.

In some embodiments, the second terminal device comprises circuitry configured to perform receiving the set of reference signals by: receiving the set of reference signals in a predetermined order. In some embodiments, the second terminal device comprises circuitry configured to perform transmitting the at least one measurement report for the at least one reference signal by transmitting the at least one measurement report on the sidelink resources in the predetermined order.

In some embodiments, the set of reference signals are a set of channel state information reference signals (CSI-RSs).

In some embodiments, the sidelink resources are physical sidelink shared channel (PSSCH) resources.

In some embodiments, the reference signal configuration at least indicates a time duration from a first transmission of a first reference signal to a second transmission of a last reference signal in the set of reference signals.

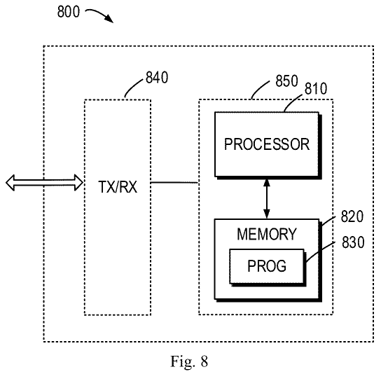

FIG. 8 is a simplified block diagram of a device 800 that is suitable for implementing embodiments of the present disclosure. The device 800 can be considered as a further example implementation of the terminal devices 110 as shown in FIG. 1. Accordingly, the device 800 can be implemented at or as at least a part of the terminal device 110-1 or the terminal device 110-2.

As shown, the device 800 includes a processor 810, a memory 820 coupled to the processor 810, a suitable transmitter (TX) and receiver (RX) 840 coupled to the processor 810, and a communication interface coupled to the TX/RX 940. The memory 820 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 830 is assumed to include program instructions that, when executed by the associated processor 810, enable the device 800 to operate in accordance with the embodiments of the present disclosure, as discussed herein with reference to FIGS. 2 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Small Data Transmission (SDT), mobility, Multicast and Broadcast Services (MBS), positioning, dynamic/flexible duplex in commercial networks, reduced capability (RedCap), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), Network-controlled Repeaters, and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1(410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The network device may have the function of network energy saving, Self-Organising Networks (SON)/Minimization of Drive Tests (MDT). The terminal may have the function of power saving.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

I/we claim:

1. A communication method, comprising:
transmitting, at a first terminal device, a set of reference signals to a second terminal device on a set of reference signal resources based on a reference signal configuration, wherein the reference signal configuration at least indicates an association in time domain between each reference signal resource for each reference signal in the set of reference signals and a sidelink resource for each measurement report with respect to each reference signal; and
receiving, from the second terminal device, at least one measurement report for at least one reference signal in the set of reference signals on sidelink resources corresponding to the set of reference signals based on the reference signal configuration.

2. The method of claim 1, wherein transmitting the set of reference signals comprises:
transmitting the set of reference signals on a set of slots; and
wherein receiving the at least one measurement report for the at least one reference signal comprises:
receiving the at least one measurement report on target slots corresponding to the set of reference signals.

3. The method of claim 1, wherein transmitting the set of reference signals comprises:
transmitting the set of reference signals on a set of slots; and
wherein receiving the at least one measurement report for the at least one reference signal comprises:
receiving the at least one measurement report on target symbols corresponding to the set of reference signals.

4. The method of claim 1, wherein transmitting the set of reference signals comprises:
transmitting the set of reference signals on a first set of slots; and
performing a repetition of the set of reference signals on a second set of slots.

5. The method of claim 1, wherein transmitting the set of reference signals comprises:
transmitting the set of reference signals on a set of symbols with a control signal between two adjacent symbols or two adjacent subsets of symbols in the set of symbols; and
wherein receiving the at least one measurement report for the at least one reference signal comprises:
receiving the at least one measurement report on target symbols corresponding to the set of reference signals.

6. The method of claim 1, wherein transmitting the set of reference signals comprises:
transmitting the set of reference signals on a set of consecutive symbols; and
wherein receiving the at least one measurement report for the at least one reference signal comprises:
receiving the at least one measurement report on target symbols corresponding to the set of reference signals.

7. The method of claim 1, wherein transmitting the set of reference signals comprises:
transmitting the set of reference signals on a first set of symbols in a first slot; and
performing a repetition of the set of reference signals on a second set of symbols in a second slot.

8. The method of any one of claims 1-7, further comprising:
receiving the reference signal configuration from a network device; and
receiving an indication for triggering transmissions of the set of reference signals.

9. The method of any one of claims 1-7, further comprising:
determining the reference signal configuration;
transmitting the reference signal configuration to the second terminal device; and
reserving a set of sidelink resources for the transmission of the set of reference signals and the reception of the at least one measurement report.

10. The method of any one of claims 1-7, wherein the reference signal configuration further comprises at least one of:
a set of transmission configuration indicator (TCI) states associated with the set of reference signal resources,
a beam sweeping type,
a beam sweeping repetition indicator, or
a set of beam sweeping timing parameters.

11. The method of any one of claims 1-7, wherein the at least one measurement report further comprises an index of the sidelink resource.

12. The method of any one of claims 1-7, wherein transmitting the set of reference signals comprises:
transmitting the set of reference signals in a predetermined order; and
wherein receiving the at least one measurement report for the at least one reference signal comprises:
receiving the at least one measurement report on the sidelink resources in the predetermined order.

13. The method of any one of claims 1-7, wherein the set of reference signals are a set of channel state information reference signals (CSI-RSs).

14. The method of any one of claims 1-7, wherein the sidelink resources are physical sidelink shared channel (PSSCH) resources.

15. The method of any one of claims 1-7, wherein the reference signal configuration at least indicates a time duration from a first transmission of a first reference signal to a second transmission of a last reference signal in the set of reference signals.

16. A communication method, comprising:
receiving, at a second terminal device, a set of reference signals from a first terminal device on a set of reference signal resources based on a reference signal configuration, wherein the reference signal configuration at least indicates an association in time domain between each reference signal resource for each reference signal in the set of reference signals and a sidelink resource for each measurement report with respect to each reference signal; and
transmitting, to the first terminal device, at least one measurement report for at least one reference signal in the set of reference signals on sidelink resources corresponding to the set of reference signals based on the reference signal configuration.

17. The method of claim 16, wherein receiving the set of reference signals comprises:
receiving the set of reference signals on a set of slots; and
wherein transmitting the at least one measurement report for the at least one reference signal comprises:
determining target slots corresponding to the set of reference signals; and
transmitting the at least one measurement report on the target slots.

18. The method of claim 16, wherein receiving the set of reference signals comprises:
receiving the set of reference signals on a set of slots with a control signal; and
wherein transmitting the at least one measurement report for the at least one reference signal comprises:
determining target symbols corresponding to the set of reference signals; and
transmitting the at least one measurement report on the target symbols.

19. The method of claim 16, wherein receiving the set of reference signals comprises:
receiving the set of reference signals on a first set of slots; and
receiving a repetition of the set of reference signals on a second set of slots.

20. The method of claim 16, wherein receiving the set of reference signals comprises:
receiving the set of reference signals on a set of symbols with a control signal between two adjacent symbols or two adjacent subsets of symbols in the set of symbols; and
wherein transmitting the at least one measurement report for the at least one reference signal comprises:
determining target symbols corresponding to the set of reference signals; and
transmitting the at least one measurement report on the target symbols.

21. The method of claim 16, wherein receiving the set of reference signals comprises:
receiving the set of reference signals on a set of consecutive symbols; and
wherein transmitting the at least one measurement report for the at least one reference signal comprises:
determining target symbols corresponding to the set of reference signals; and
transmitting the at least one measurement report on the target symbols.

22. The method of claim 16, wherein receiving the set of reference signals comprises:
receiving the set of reference signals on a first set of symbols in a first slot; and
receiving a repetition of the set of reference signals on a second set of symbols in a second slot.

23. The method of any one of claims 16-22, further comprising:
receiving the reference signal configuration from a network device; or
receiving the reference signal configuration from the first terminal device.
receiving an indication for triggering of transmissions of the set of reference signals.

24. The method of any one of claims 16-22, wherein the reference signal configuration further comprises at least one of:
a set of transmission configuration indicator (TCI) states associated with the set of reference signal resources,
a beam sweeping type,
a beam sweeping repetition indicator, or
a set of beam sweeping timing parameters.

25. The method of any one of claims 16-22, wherein the at least one measurement report further comprises an index of the sidelink resource.

26. The method of any one of claims 16-22, wherein receiving the set of reference signals comprises:
receiving the set of reference signals in a predetermined order; and
wherein transmitting the at least one measurement report for the at least one reference signal comprises:
transmitting the at least one measurement report on the sidelink resources in the predetermined order.

27. The method of any one of claims 16-22, wherein the set of reference signals are a set of channel state information reference signals (CSI-RSs).

28. The method of any one of claims 16-22, wherein the sidelink resources are physical sidelink shared channel (PSSCH) resources.

29. The method of any one of claims 16-22, wherein the reference signal configuration at least indicates a time duration from a first transmission of a first reference signal to a second transmission of a last reference signal in the set of reference signals.

30. A terminal device comprising:
a processor; and
a memory coupled to the processor and storing instructions thereon, the instructions, when executed by the processor, causing the terminal device to perform acts comprising the method according to any of claims 1-15 or any of claims 16-29.

31. A computer readable medium having instructions stored thereon, the instructions, when executed on at least one processor, causing the at least one processor to perform the method according to any of claims 1-15 or any of claims 16-29.
